(19) United States
(12) Patent Application Publication
(10) Pub. No.: US 2021/0350391 A1
(43) Pub. Date: Nov. 11, 2021

(54) METHODS AND SYSTEMS FOR PROVIDING A PERSONALIZED USER INTERFACE

(71) Applicant: CaaStle, Inc., New York, NY (US)

(72) Inventors: Yu-Cheng TSAI, New York, NY (US); Steven SHIMOZAKI, New York, NY (US); Dongming JIANG, New York, NY (US); Georgiy GOLDENBERG, New York, NY (US); Marissa CALABRESE, New York, NY (US); Vera MUSICARO, New York, NY (US); Lei YU, New York, NY (US)

(73) Assignee: CaaStle, Inc., New York, NY (US)

(21) Appl. No.: 16/868,903

(22) Filed: May 7, 2020

(51) Int. Cl. G06Q 30/02; G06Q 30/06; G06N 20/00

(52) U.S. Cl. CPC G06Q 30/0201; G06Q 30/0205; G06N 20/00; G06Q 30/0643

(57) ABSTRACT

A computer-implemented method for providing a personalized user interface to a user may include obtaining customer data; obtaining customer article data; obtaining customer interface activity data of the at least one customer; training a prediction model; obtaining at least one of user data, user article data, or user interface activity data of a user of the apparel subscription application; determining a rank of one or more articles based on the prediction model; obtaining environmental data including values of one or more environmental factors associated with user article data; and providing, to the user, the personalized user interface associated with the apparel subscription application to the user based on the rank of the one or more articles and the environmental data.

### TECHNICAL FIELD

Various embodiments of the present disclosure relate generally to providing a personalized user interface to a user, and, more particularly, to providing the personalized user interface to a user via a prediction model.

### BACKGROUND

Fashion and apparel style management may pose several challenges for apparel rental subscription services. For example, one such challenge may be that fashion and apparel style management may require a collection of article categories (e.g., article styles), which are catchy, trending, and seasonally appropriate, the collection being constantly adapted to evolving and shifting interest of customers or users of the apparel rental subscription services. Customers or users of the apparel rental subscription services may look for articles worn to ad-hoc social events or may desire to have the ability to access various fashion brands without commitment. Since fashion may be evolving every day, and old trends may be re-emerging as well, generating a personalized user interface including a collection of article categories that can meet customers' or users' needs may be advantageous to retain subscribers for the apparel rental subscription services. Traditionally, a team of visual merchandisers or tenants (e.g., retailers, brands, department stores, or supply-side vendors associated with apparel rental subscription services) may be responsible for curating a collection of article categories for each customer or user based on predetermined criteria (e.g., white colored articles are trending this season, patterns and colors of articles that are best-suited for year-end holidays, etc.), which may be labor intensive, making the process of selecting article categories unscalable. Additionally, the traditional method of selecting articles by visual merchandisers may produce a number of issues, including lower utilization of older but relevant articles, or high concentration of demands to a small subset of article category collections, which may put pressure on the supply of recently launched articles.

The present disclosure is directed to overcoming one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, methods and systems are disclosed for providing a personalized user interface to a user. The methods and systems disclosed herein may overcome or alleviate issues and problems mentioned above. For example, the methods and systems disclosed herein may cluster or classify users to different user personae (e.g., user's preference of a certain article category) based on user interface activity data. Secondly, the methods and systems disclosed herein may allow automatic personalized user interface generation based on one or more learning models (e.g., a neural network), with a range of data pulled from customer/user interface activity data, customer/user data, customer/user article data, and environmental data collected by and stored in one or more databases associated with apparel rental subscription services. The personalized user interface may allow for preferable user experience and business efficiencies throughout the life cycles of the apparel rental subscription services, by automatically surfacing older and relevant articles and reducing human involvement in the process of personalized user interface generation.

In an aspect, a computer-implemented method for providing a personalized user interface to a user may comprise obtaining, via one or more processors, customer data including customer identification data of at least one customer of an apparel subscription application, the customer identification data including customer demographic data of the at least one customer; obtaining, via the one or more processors, customer article data including article information associated with the at least one customer of the apparel subscription application; obtaining, via the one or more processors, customer interface activity data of the at least one customer, customer interface activity data including one or more interactive activities between the at least one customer and a customer interface associated with the apparel subscription application; training, via the one or more processors, a prediction model based on the customer data, the customer article data, and the customer interface activity data of the at least one customer; obtaining, via the one or more processors, at least one of user data, user article data, or user interface activity data of a user of the apparel subscription application; determining, via the one or more processors, a rank of one or more articles based on the prediction model by inputting the at least one of the user data, the user article data, or the user interface activity data, the rank indicating a level of preference of the user regarding the one or more articles; obtaining, via the one or more processors, environmental data including values of one or more environmental factors, the one or more environmental factors including at least one of a season factor, a trend factor, or an economic factor; and providing, to the user, the personalized user interface associated with the apparel subscription application to the user based on the rank of the one or more articles and the environmental data.

In another aspect, a computer system for providing a personalized user interface to a user may comprise a memory storing instructions; and one or more processors configured to execute the instructions to perform operations. The operations may include obtaining, via one or more processors, customer data including customer identification data of at least one customer of an apparel subscription application, the customer identification data including customer demographic data of the at least one customer; obtaining, via the one or more processors, customer article data including article information associated with the at least one customer of the apparel subscription application; obtaining, via the one or more processors, customer interface activity data of the at least one customer, customer interface activity data including one or more interactive activities between the at least one customer and a customer interface associated with the apparel subscription application; training, via the one or more processors, a prediction model based on the customer data, the customer article data, and the customer interface activity data of the at least one customer; obtaining, via the one or more processors, at least one of user data, user article data, or user interface activity data of a user of the apparel subscription application; determining, via the one or more processors, a rank of one or more articles based on the prediction model by inputting the at least one of the user data, the user article data, or the user interface activity data, the rank indicating a level of preference of the user regarding the one or more articles; obtaining, via the one or more processors, environmental data including values of one or more environmental factors, the one or more environmental factors including at least one of a season factor, a trend factor, or an economic factor; and providing, to the user, the personalized user interface associated with the apparel subscription application to the user based on the rank of the one or more articles and the environmental data.

In yet another aspect, a non-transitory computer readable medium for use on a computer system may contain computer-executable programming instructions for performing a method of providing a personalized user interface, and the method may include obtaining, via one or more processors, customer data including customer identification data of at least one customer of an apparel subscription application, the customer identification data including customer demographic data of the at least one customer; obtaining, via the one or more processors, customer article data including article information associated with the at least one customer of the apparel subscription application; obtaining, via the one or more processors, customer interface activity data of the at least one customer, customer interface activity data including one or more interactive activities between the at least one customer and a customer interface associated with the apparel subscription application; training, via the one or more processors, a prediction model based on the customer data, the customer article data, and the customer interface activity data of the at least one customer; obtaining, via the one or more processors, at least one of user data, user article data, or user interface activity data of a user of the apparel subscription application; determining, via the one or more processors, a rank of one or more articles based on the prediction model by inputting the at least one of the user data, the user article data, or the user interface activity data, the rank indicating a level of preference of the user regarding the one or more articles; obtaining, via the one or more processors, environmental data including values of one or more environmental factors, the one or more environmental factors including at least one of a season factor, a trend factor, or an economic factor; and providing, to the user, the personalized user interface associated with the apparel subscription application to the user based on the rank of the one or more articles and the environmental data.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment in which methods, systems, and other aspects of the present disclosure may be implemented, according to one or more embodiments.

FIG. 2 depicts an exemplary server system in which methods, systems, and other aspects of the present disclosure may be implemented, according to one or more embodiments.

FIG. 3 depicts an exemplary flowchart illustrating a method for providing a personalized user interface to a user, according to one or more embodiments.

FIG. 4 depicts another exemplary flowchart illustrating a method for providing a personalized user interface to a user, according to one or more embodiments.

FIG. 5A depicts an exemplary flowchart for training a prediction model with embedded data, according to one or more embodiments.

FIG. 5B depicts an exemplary flowchart with one or more steps that may be performed between a step 502 of obtaining customer article data, as discussed with respect to FIG. 5A, and a step 504 of generating embedded article data based on customer article data as discussed with respect to FIG. 5A, according to one or more embodiments.

FIG. 6 depicts an exemplary flowchart illustrating the application of the trained prediction model, according to one or more embodiments.

FIGS. 7A-7D depicts exemplary personalized user interfaces, according to one or more embodiments of the present disclosure.

FIG. 8 depicts a comparison of a plurality of exemplary models, including a persona-based model, a personalization-based model, and a human-curated-based model, which are associated with a method for providing a personalized user interface to a user-according to one or more embodiments.

FIG. 9 illustrates an example of a computing device 900 of a computer system.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompanying drawings. As will be discussed in more detail below, in various embodiments, data such as customer data, customer article data, customer interface activity data, user data, user article data, user interface activity data, and/or environmental data may be used to provide a personalized user interface to a user.

The method described herein may overcome issues associated with apparel rental subscription services, such as fast shifting fashion trends and interest of customers or users. Additionally, the method described herein may enable generating personalized user interfaces based on the customer and/or user demands in real-time, removing out-of-stock articles, and surfacing older, relevant, and seasonally appropriate articles. The method described herein may segment customers/users into various customer/user personae based on a certain user interface activity data and provide an automated system that allows for generation of personalized user interface based on historical user/customer interface activity data, customer/user data, and/or customer/user article data. The methods and systems can also be programmed to account for environmental data including a season factor (e.g., seasonality), a trend factor (e.g., fashion trending), or an economic factor (e.g., business key performance indicators related to apparel rental subscription services).

The method and system may train prediction models (e.g., neural network-based models) using user/customer interface activity data, customer/user data, and/or customer/user article data, produce a list of article categories ordered by the probability of an article category being chosen, allow for automatic generation of personalized user interface for each persona, filter article categories based on environmental data (e.g., business metrics related to the apparel rental subscription service and seasonality (i.e. whether in season)), blend in the article mixes of latest new-arrivals in personalized user interface based on historical customer/user interface activity data (e.g., percentage of article worn, article customer rating, etc.), display article categories shown in personalized user interface for each user persona or article category, or present recommended articles to customers or users of the apparel rental subscription service.

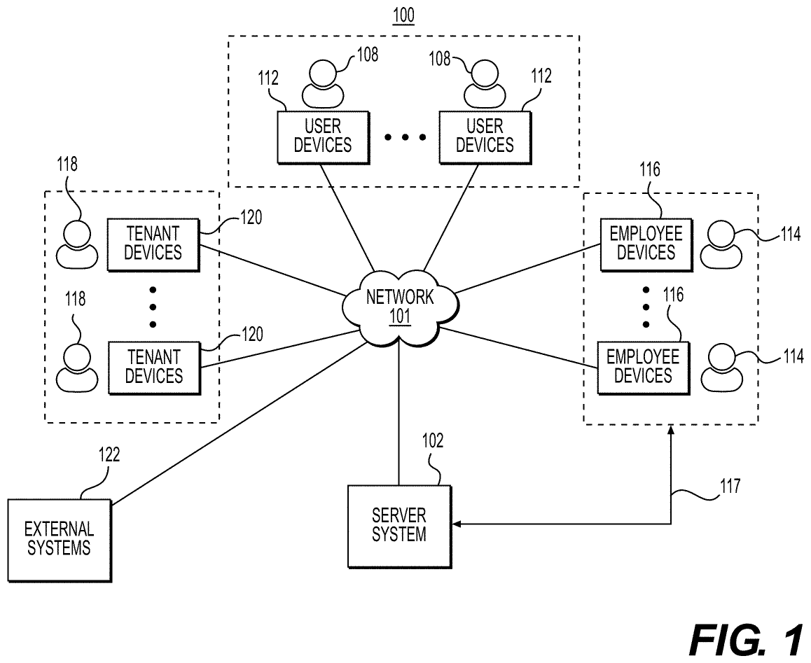

FIG. 1 shows an exemplary environment 100, according to one or more embodiments of the present disclosure. As shown, the exemplary environment 100 may include one or more networks 101 that interconnect a server system 102, user devices 112, employee devices 116, tenant devices 120, and external systems 122. The one or more networks 101 may be, for example, one or more of a cellular network, a public land mobile network, a local area network, a wide area network, a metropolitan area network, a telephone network, a private network, an ad hoc network, an intranet, the Internet, a fiber optic based network, a cloud computing network, etc. User devices 112 may be accessed by users or customers 108, employee devices 116 may be accessed by authorized employees 114, and tenant devices 120 may be accessed by employees of tenant entities 118. In some implementations, employee devices 116 may be used to perform the functions of the tenant devices 120 and/or the user devices 112. Server system 102 may comprise one or more servers and one or more databases, which may be configured to store and/or process a plurality of data, microservices, and service components, and/or associated functions thereof. In some embodiments, the server system may comprise an algorithm module. The one or more servers may comprise the algorithm module in some embodiments. The algorithm module may comprise a machine learning module including one or more neural networks. In some embodiments, the one or more neural networks may include deep convolutional neural networks (DCNN), region based convolutional neural networks (R-CNN), and/or Mask R-CNN. A Mask R-CNN and R-CNN may include one or more convolutional neural network models designed for object detection and image segmentation within an image in order to obtain article images with the background removed. DCNNs, R-CNNs, Mask-RCNNs may be configured to analyze visual imagery, for example, for analyzing, classifying, and identifying one or more products within an image depicting the one or more products. In some embodiments, the one or more neural networks may comprise one or more image segmentation based neural networks and one or more image classification based neural networks. Exemplary neural networks, such as DCNNs, R-CNNs, and Mask-RCNNs are described in U.S. patent application Ser. No. 16/783,289, filed on Feb. 6, 2020, which is hereby incorporated by reference in its entirety.

Users or customers 108 may access the server system 102 through the one or more networks 101 using user devices 112. Each device among the user devices 112 may be any type of computing device (e.g., personal computing device, mobile computing devices, etc.) which allows users or customers 108 to display a web browser or a web based application for accessing the server system 102 through the network 101. The user devices 112 may, for example, be configured to display a web browser, a web based application, or any other user interface (e.g., one or more mobile applications) for allowing users or customers 108 to exchange information with other device(s) or system(s) in the environment 100 over the one or more networks 101. For example, a device among the user devices 110 may load an application with a graphical user interface (GUI), and the application may display on the GUI one or more apparel recommendations for closeting (e.g., adding to a virtual wardrobe) by the user. Users or customers 108 accessing user devices 112 may be, for example, users and/or potential users of apparel rental subscription services and/or apparel made available for subscription based distribution via electronic transactions and physical shipment. Additionally, or alternatively, users or customers 108 may access user devices 112 to, for example, manage one or more user accounts, view catalogs, configure one or more user profiles, engage in customer service communications, make purchase orders, track shipments, generate shipments, monitor order fulfillment processes, initiate or process returns, order apparel for purchase, provide feedback, refer other users, navigate through various features such as size advisor, perform personalized discovery, and/or make recommendations.

Employee devices 116 may be configured to be accessed by one or more employees 114, including, for example, editors, purchasers, customer service employees, marketer employees, warehouse employees, analytics employees, or any other employees who are authorized and/or authenticated to perform tasks, operations, and/or transactions associated with the server system 102, and/or the external systems 122. In one embodiment, employee devices 116 are owned and operated by the same entity or at least an affiliate of the entity operating the apparel rental subscription services or e-commerce (e.g., clothing as a service (CaaS)) business hosted on server systems 102. Each device among the employee devices 116 may be any type of computing device (e.g., personal computing device, mobile computing devices, etc.). The employee devices 116 may allow employees 114 to display a web browser or an application for accessing the server system 102 and/or the external systems 122, through the one or more networks 101. For example, a device among the one or more of the employee devices 116 may load an application with graphical user interface (GUI), and the application may display on the GUI one or more warehouse operations associated with providing CaaS to users or customers 108. In some implementations, the employee devices 116 may communicate directly with the server system 102 via communications link 117 bypassing public networks 101. Additionally, or alternatively, the employee devices 116 may communicate with the server system 102 via network 101 (e.g., access by web browsers or web based applications).

Tenant devices 120 may be configured to be accessed by one or more tenants 118. Each device among the tenant devices 120 may be any type of computing device (e.g., personal computing device, mobile computing devices, etc.). As used herein, each tenant, among one or more tenants 118, may refer to an entity or merchant that allocates and/or supplies one or more specific collections of apparel for the CaaS inventory. For example, each of the one or more tenants 118 may be a retailer, a designer, a manufacturer, a merchandiser, or a brand owner entity that supplies one or more collections of wearable items to the CaaS inventory managed and/or accessed by the server system 102. Tenants 118 may use one or more electronic tenant interfaces (e.g., a catalog content management system associated with each tenant) to provide the server system 102 with wearable item data (e.g., apparel information) that describe apparel or wearable items made available for electronic transactions on server system 102. For example, one or more catalogs for each of the one or more tenants 118 may be generated and/or updated at the server system 102 dynamically and/or periodically. Tenant devices 120 may serve as access terminals for the tenants 118, for communicating with the electronic tenant interfaces and/or other subsystems hosted at the server system 102. The tenant devices 120 may, for example, be configured to display a web browser, an application, or any other user interface for allowing tenants 118 to load the electronic tenant interfaces and/or exchange data with other device(s) or system(s) in the environment 100 over the one or more networks 101.

External systems 122 may be, for example, one or more third party and/or auxiliary systems that integrate and/or communicate with the server system 102 in performing various CaaS tasks. External systems 122 may be in communication with other device(s) or system(s) in the environment 100 over the one or more networks 101. For example, external systems 122 may communicate with the server system 102 via API (application programming interface) access over the one or more networks 101, and also communicate with the employee devices 116 via web browser access over the one or more networks 101.

As indicated above, FIG. 1 is provided merely as an example. Other examples that differ from the example environment 100 of FIG. 1 are contemplated within the scope of the present embodiments. In addition, the number and arrangement of devices and networks shown in environment 100 are provided as an example. In practice, there may be additional devices, fewer devices and/or networks, different devices and/or networks, or differently arranged devices and/or networks than those shown in environment 100. Furthermore, two or more devices shown in FIG. 1 may be implemented within a single device, or a single device shown in FIG. 1 may be implemented as multiple, distributed devices. Additionally, or alternatively, one or more devices may perform one or more functions of other devices in the example environment 100. For example, employee devices 116 may be configured to perform one or more functions of tenant devices 120, in addition to their own functions.

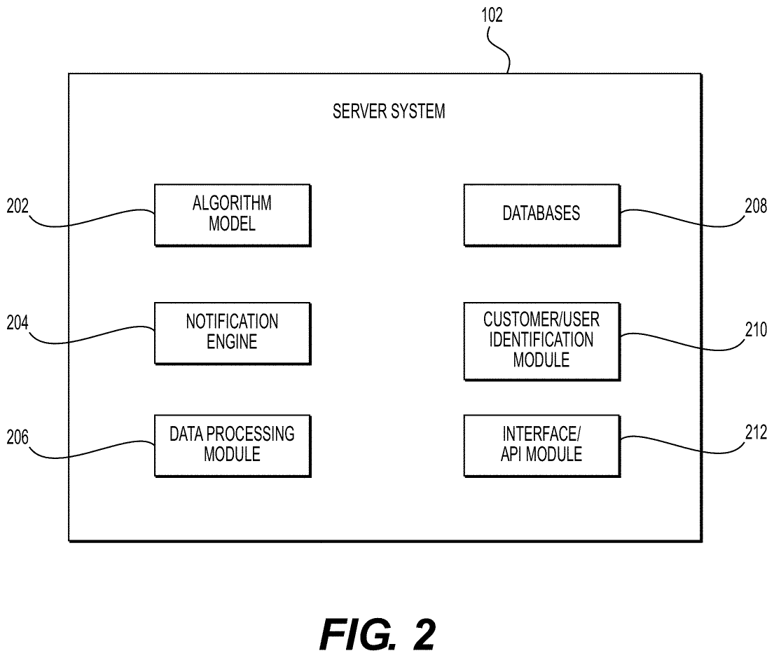

FIG. 2 depicts an exemplary server system in which methods, systems, and other aspects of the present disclosure may be implemented. The server system 102 may have one or more processors configured to perform methods described in this disclosure. The server system 102 may include one or more modules, models, or engines. The one or more modules, models, or engines may include an algorithm model 202, a notification engine 204, a data processing module 206, one or more databases 208, a customer/user identification module 210, and/or an interface/API module 212, which may each be software components stored in or by the server system 102. The server system 102 may be configured to utilize one or more modules, models, or engines when performing various methods described in this disclosure. In some examples, the server system 102 may have a cloud computing platform with scalable resources for computation and/or data storage, and may run one or more applications on the cloud computing platform to perform various computer-implemented methods described in this disclosure. In some embodiments, any of the disclosed one or more modules, models, or engines may be combined to form fewer modules, models, or engines. In some embodiments, any of the disclosed one or more modules, models, or engines may be separated into separate, more numerous modules, models, or engines. In some embodiments, any of the disclosed one or more modules, models, or engines may be removed while others may be added.

The algorithm model 202 may include a plurality of algorithm models. The algorithm model 202 may include a prediction model. Details of the prediction model are described elsewhere herein. The notification engine 204 may be configured to generate and communicate (e.g., transmit) one or more notifications (e.g., the personalized user interface) to a user device 112, employee device 116, or tenant device 120 via network 101. The data processing module 206 may be configured to process, retrieve, store, or otherwise aggregate or manage current or historical data (e.g., customer data, customer article data, user data, user article data) from the one or more databases 208. The data processing module 206 may be configured to clean, process, or standardize data (e.g., customer data, customer article data, user data, user article data) received in the server system 102. One or more algorithms may be used to clean, process, or standardize the data. The one or more databases 208 may be configured to store a plurality of types of data (e.g., customer data, customer article data, customer interface activity data, user data, user article data, user interface activity data, or environmental data). The customer/user identification module 210 may manage or authenticate identification data or any information regarding a user or customer for each user or customer accessing the server system 102. In one implementation, the identification data associated with each user/customer may be stored to, and retrieved from, one or more databases 208. The interface/API module 212 may allow the user, customer, employee, or tenant to interact with one or more modules, models, or engines of the server system 102. In at least some instances, a customer may be the same as a user, who subscribes or uses the apparel rental subscription services. However, in other instances, a customer may be different from a user (e.g., the customer is a new customer, and the user is a prospective subscriber), and the data obtained from a customer is used to train a prediction model.

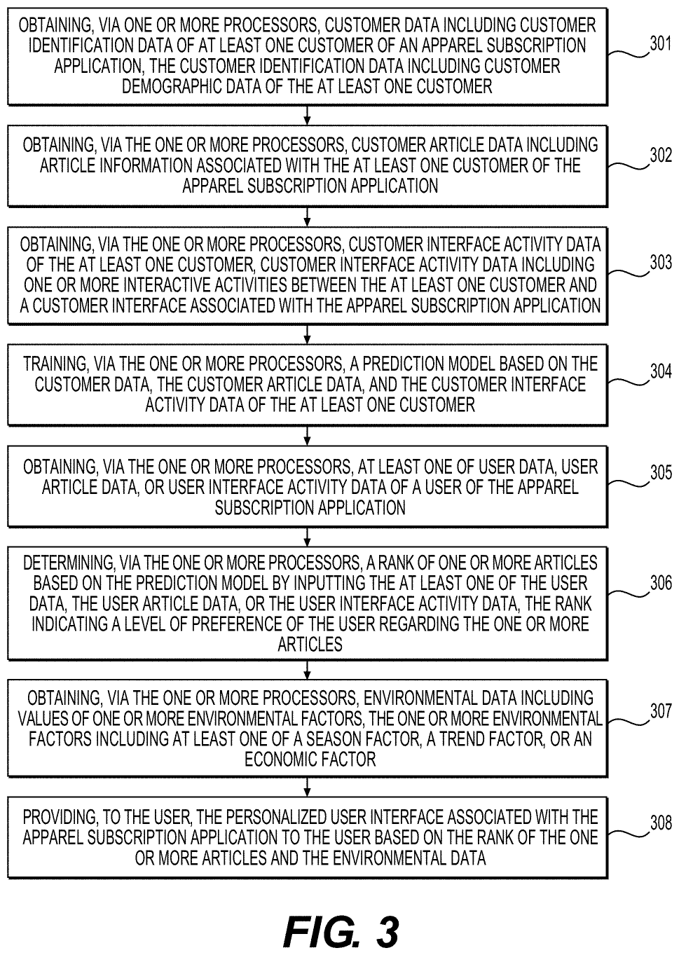

FIG. 3 is an exemplary flowchart illustrating a method for providing a personalized user interface to a user, according to one or more embodiments. The method may be performed by the exemplary environment 100.

Step 301 may include obtaining, via one or more processors, customer data including customer identification data of at least one customer of an apparel subscription application. The customer may be an existing customer for the apparel rental subscription service. The customer identification data may include at least a customer name and biometric data of the customer. The biometric data may include any information related to human characteristics of the customer. The biometric data may include behavioral characteristics related to the pattern of behavior of the customer. The identification data of the customer may further include contact information (e.g., address, phone numbers, e-mail addresses, etc.), and additional information pertaining to the user. The additional information may include customer preference information, anonym ized aggregated demographic data (e.g., age, gender, marital status, income level, educational background, number of children in household, etc.), information of customer persona (e.g., article categories chosen by the customer), customer's choices of article brands and sizes, and other data related to the customer.

Step 302 may include obtaining, via one or more processors, customer article data including article information associated with at least one customer of the apparel subscription application. The customer may be an existing customer for the apparel rental subscription service. The customer article data may comprise information of one or more articles that were selected or preferred by the customer. Such customer article data may be provided by a customer via a user interface displayed on a user device. The article information may be determined by one or more algorithms (e.g., an algorithm that defines preferred article categories for a user). The customer article data may include any suitable information regarding the one or more articles or the customer, for example, customer article preferences (preferences or reviews regarding favorite article categories, favorite department stores for articles, images of the article, brands, or retailers, etc.), a transaction amount of renting the one or more articles, past spending levels on one or more articles, a frequency of shopping by the customer, brand loyalty exhibited by the customer, or how much the customer spends in an average transaction. The customer article data may include one or more identifiers (e.g., unique article identifiers or tags) associated with one or more articles. These identifiers may be generated by employees of the apparel rental subscription services. The one or more identifiers may encode or otherwise provide information including article category, style, size, material, season, patterns (e.g., animals, polka dots, etc.), sleeve length, neckline shape, or hemline length. The article category may include blazer, coat, blouse, jacket, dress, jeans, jumper, pants, sweaters, swimsuit, T-shirt, shirt, suit, underwear, or gown. In another example, the article categories may include dress, pant, blazer, top, cardigan, skirt, or outerwear.

Step 303 may include obtaining, via one or more processors, customer interface activity data of at least one customer. The customer may be an existing customer for the apparel rental subscription service. The customer interface activity data may include one or more interactive activities between one customer and a customer interface associated with the apparel rental subscription application. The customer interface activity data may further indicate at least a level of interaction of one of the one or more interactive activities between the customer and the customer interface displayed on the user device associated with the customer. The one or more interactive activities may include at least one of an action of clicking a link, an action of typing a search term, or an action of selecting a filter performed by the customer. The user device 112 may be capable of accepting customer inputs via one or more interactive components of the user device 112, such as a keyboard, button, mouse, touchscreen, touchpad, joystick, trackball, camera, microphone, or motion sensor input. For instance, the customer of the apparel rental subscription services may open an application provided by the apparel rental subscription services and click on one or more images of articles presented on the user interface, and the number of clicks to certain article categories may be the customer interface activity data. In another example, a customer of the apparel rental subscription services may type a brand name of a piece of article via a keyboard provided on the display of the device 112 associated with the customer, the name of the brand may be the customer interface activity data. In yet another example, the customer of the apparel rental subscription services may click on one or more selections associated with one or more articles displayed on a display of the user device 112, and the one or more selections may be the customer interface activity data. The one or more selections may be in a form of a link, button, or hyperlink. The customer interface activity data may be one or more logs associated with the apparel rental subscription services (e.g., clicking events when a customer adds an article into his/her virtual wardrobe) collected from an application provided by the apparel rental subscription services. For example, when a customer opens the application provided by the apparel rental subscription services, she/he may provide her/his preferred or frequent shopping choices of article brands, sizes, billing zip code, and editor (e.g., one or more user preferences supplied by the customer) during the activation process. The customer may then start adding articles into her/his virtual wardrobe provided in the application. The articles added by the customer may be associated with, or identified by, identifiers stored in one or more databases.

Step 304 may include training, via one or more processors, a prediction model based on the customer data, the customer article data, and the customer interface activity data of at least one customer. Training the prediction model may include clustering or classifying at least one customer based on the customer interface activity data, the customer data, and/or the customer article data. During the model training process, customer interface activity data may be from historical customer interface activity data. In one example, a customer may be clustered into a persona based on the article category chosen by the customer. For example, a customer who predominantly adds printed dresses (e.g., to a virtual closet, as described above) may be different from another customer who mostly selects solid tops and blazers. Using the customer data, the customer article data, and the customer interface activity data (e.g., one or more identifiers), different customers may be clustered or segmented into different customer persona. Customer persona can be one of the attributes of customer data. The customer data may be represented as a sparse vector. A sparse vector may be a vector including a plurality of vector elements as zero. The vector element may be a value (e.g., a numerical number) represented in a vector. For example, customer data for a customer A may include a person having a preference to dresses, living in California, preferring dresses from brand A, size 8, and jeans from brand B, size 10. To convert such customer data to a mathematical form, a sparse vector may be used to encode such information, where the vector element 1-10 of the vector may refer to 10 possible article categories (e.g., dress, top, pant, etc.), the vector element 11-60 may represent 50 possible states, and the vector element 61-180 may refer to possible selections of article brands and sizes.

The prediction model may be of any suitable form, and may include, for example, a neural network. A neural network may be software representing a human neural system (e.g., a cognitive system). A neural network may include a series of layers termed “neurons” or “nodes.” A neural network may comprise an input layer, to which data is presented, one or more internal layers, and an output layer. The number of neurons in each layer may be related to the complexity of a problem to be solved. Input neurons may receive data being presented and then transmit the data to the first internal layer through the connections' weight. The trained machine learning algorithm may include a convolutional neural network (CNN), a deep neural network, a recurrent neural network (RNN), a region based convolutional neural networks (R-CNN), Mask R-CNN, or any other suitable type of neural network.

The prediction model may be trained by supervised, unsupervised, or semi-supervised learning using training sets comprising data of types similar to the type of data used as the model input. For example, the training set used to train the model may include any combination of the following: customer data, customer article data, customer interface activity data, environmental data, or any other data. Accordingly, the machine learning model may be trained to map input variables (e.g., customer interface activity data) to a quantity or value of a rating of a customer's likelihood to rent or purchase an article (e.g., a customer's preference of an article). That is, the prediction model may be trained to determine a quantity or value of a rating of the customer's likelihood to purchase or rent an article (e.g., by placing the article in a virtual closet) as a function of various input variables. The prediction model may include a classification algorithm. The classification algorithm may include linear classifiers (e.g., logistic regression, Naïve Bayes classifier), support vector machines, quadratic classifiers, Kernel estimation (e.g., k-nearest neighbor), boosting, or decision trees (e.g., random forests). The k-nearest neighbors algorithm (k-NN) may include a training phase including storing the feature vectors and class labels of the training samples. The k-nearest neighbors algorithm (k-NN) may include a classification phase including k as a user-defined constant and an unlabeled vector (a query or test point) classified by assigning the label which is most frequent among the k training samples nearest to that query point.

Training the prediction model may include training the prediction model with one or more loss functions. The one or more loss functions may be customized in order to maximize the probability of one or more articles being shown to a customer or a user who is more likely to choose the one or more articles. The one or more loss functions may be used to evaluable the prediction model. The one or more loss functions may be minimized for a prediction model.

With continued reference to FIG. 3, the method may further include, prior to training the prediction model (as described above with respect to step 304), converting the customer data and the customer article data to embedded customer data and embedded article data, respectively. Embedded customer data and embedded article data may include any extra information such as additional demographic data and other information associated with the customer or image of the article added by customers.

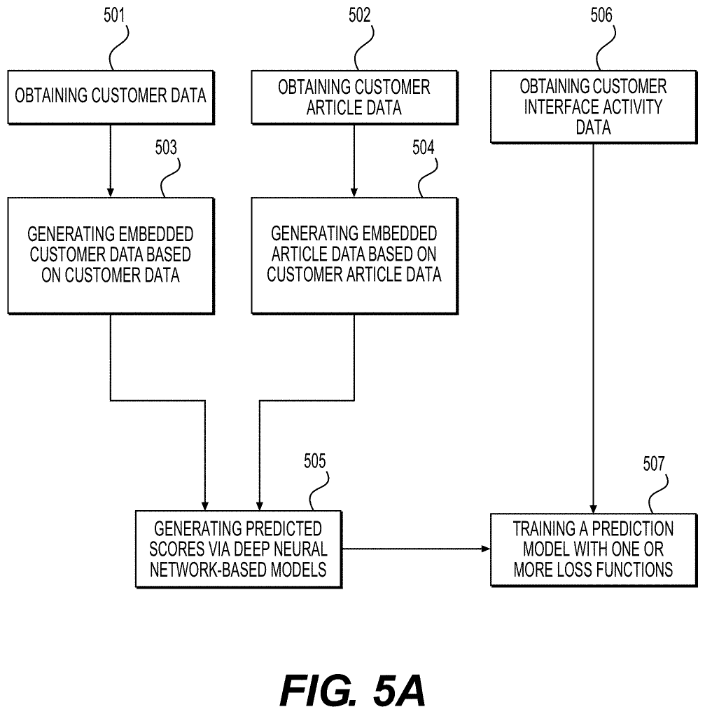

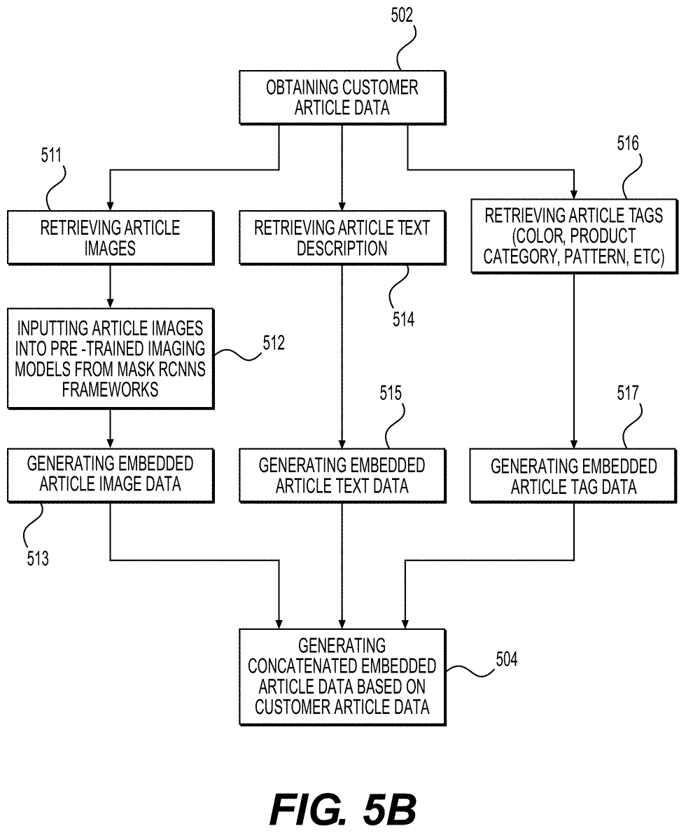

As described above, step 304 may include training the prediction model. In at least some embodiments, training the prediction model may be performed based on the embedded customer data, the embedded article data, and the customer interface activity data of at least one customer. In particular, FIG. 5A depicts an exemplary flowchart for training a prediction model with embedded data, according to one or more embodiments. With reference to FIG. 5A, training the prediction model may include a step 501 of obtaining customer data, a step 502 of obtaining customer article data, a step 503 of generating embedded customer data (e.g., an embedded customer representation graph) based on customer data, a step 504 of generating embedded article data (e.g., an embedded article representation graph) based on customer article data, a step 505 of generating predicted scores via one or more neural network models (e.g., deep neural network) based on the embedded customer data and the embedded article data, a step 506 of obtaining customer interface activity data, and a step 507 of training a prediction model with one or more loss functions based on the predicted score and customer interface activity data. Details of customer data, customer article data, and customer interface activity data are described elsewhere herein. The embedded data (e.g., embedded customer data, embedded article data, or embedded user data) may be formed by a multi-dimensional tensor space, which may learn to encode certain characteristics of users, customers or articles. The embedded data may be used to predict articles most likely to be chosen (e.g., placed in a virtual closet) for each customer or user persona, and may rank the articles based on a predicted score of each article category. The higher the score is, the better chance an article may be selected by a given customer/user persona. The neural network may use sparse vector or a dense representation of embedded vectors (e.g., embedded vectors of the embedded customer data) with the input being the sparse vector. Before the training of models beings, the embedded vectors may be randomly generated numbers. The neural network or prediction model may learn to reduce errors by iterating the numbers in the embedded data. In this case, the neural network or prediction model may match the articles with higher chances to be selected by a user with a particular user persona. The embedded data may refer to the randomly-generated tensors (e.g., numbers). In some embodiments, numbers may be randomly-generated at the beginning of the training of the prediction model, and may be gradually converged to fixed numbers during the training of the prediction model.

FIG. 5B depicts an exemplary flowchart with one or more steps that may be performed between a step 502 of obtaining customer article data, as discussed with respect to FIG. 5A, and a step 504 of generating embedded article data based on customer article data as discussed with respect to FIG. 5A, according to one or more embodiments. As shown in FIG. 5B, the flowchart may include a step 502 of obtaining customer article data, a step 511 of retrieving article images from the obtained customer article data, a step 512 of inputting article images into pre-trained imaging models from Mask R-CNNs frameworks, a step of 513 of generating embedded article image data, a step 514 of retrieving article text description, a step 515 of generating embedded article text data based on the article text description, a step 516 of retrieving article tags (e.g., color, article category, pattern), a step 517 of generating embedded article tag data based on the article tags, and a step 504 of generating embedded article data based on the embedded article image data, the embedded article text data, and embedded article tag data. When obtaining customer article data, the article data may include article image, article text description, and article tag information (e.g., product type, sleeve, hemline). The article image selected by a user/customer may be passed through an already trained (pre-trained) Mask RCNNs and DCNNs models (e.g., as described in U.S. patent application Ser. No. 16/783,289). The pre-trained models may generate a trained embedded vector, representing the dense information of the article image. Concurrently, the article text description may be converted into an embedded vector using DNNs, one-dimensional CNNs, RNNs, or long short-term memory (LSTM) models, while the article tags may be transformed to an embedded vector using DNNs. Due to the flexibility of DNNs modeling framework, the embedded vectors of article images, article text descriptions, and article tags may be concatenated, resulting in a combined embedded vector, representing a given input customer article data.

Referring back to FIG. 3, step 305 may include obtaining, via the one or more processors, at least one of user data, user article data, and/or user interface activity data of a user of the apparel subscription application. The user may not be at least one customer, but rather may be a prospective customer or new customer. In this case, the user data, user article data, and/or user interface activity data is therefore not available and may not be used in training the prediction model. In some embodiments, if the user is new to the apparel rental subscription service, user interface activity data may not be available when the user first uses the application provided by the apparel rental subscription service. In this case, user data and user article data, but not user interface activity data, may be obtained.

The user data may include user identification data of the user. The user identification data may include at least a user name and biometric data of the user. The biometric data may include any information related to human characteristics of the user. The biometric data may include behavioral characteristics related to the pattern of behavior of the user. The identification data of the user may further include contact information (e.g., address, phone numbers, e-mail addresses, etc.), and additional information pertaining to the user. The additional information may include user preference information, anonymized aggregated demographic data (e.g., age, gender, marital status, income level, educational background, number of children in household, etc.), information of user persona (e.g., article categories chosen by the customer), user's choices of article brands and sizes, and other data related to the user.

The user article data may include article information associated with the user of the apparel subscription application. The user article data may comprise information of one or more articles that were selected or preferred by the user. Such user article data may be provided by a user via a user interface displayed on a user device. The article information may be determined by one or more algorithms (e.g., an algorithm that defines preferred article categories for a user). The user article data may include any suitable information regarding the one or more articles or the user, for example, user article preferences (preferences or reviews regarding favorite article categories, favorite department stores for articles, etc.), a transaction amount for renting the one or more articles, past spending levels on one or more articles, a frequency of shopping by the user, brand loyalty exhibited by the user, or how much the user spends in an average transaction. The user article data may include one or more identifiers (e.g., unique article identifiers or tags) associated with one or more articles. These identifiers may be generated by employees of the apparel rental subscription services, for example. The one or more identifiers may provide information including article category, style, size, material, season, patterns (e.g., animals, polka dots), sleeve length, neckline shape, or hemline length. The user article data may include at least one of the image of the article, the text description of the article, or the embedded image information derived from images of articles that a customer/user adds into her/his virtual wardrobe, which may be pre-trained using the Mask-RCNN models as described above. The user article data may include the article text description, which may be used as an input to generate embedded vectors using RNN modeling.

The user interface activity data may include one or more interactive activities between one user and a user interface associated with the apparel rental subscription application. The user interface activity data may indicate at least a level of interaction of one of the one or more interactive activities between the user and the user interface displayed on the user device associated with the user. The one or more interactive activities may include at least one of an action of clicking a link, an action of typing a search term, or an action of selecting a filter performed by the user. The user device 112 may be capable of accepting user inputs via one or more interactive components of the user device 112, such as a keyboard, button, mouse, touchscreen, touchpad, joystick, trackball, camera, microphone, or motion sensor input. For instance, the user of the apparel rental subscription service may open an application provided by the apparel rental subscription service and click on one or more images of articles presented on the user interface, and the number of clicks to certain article categories may be the user interface activity data. In another example, a user of the apparel rental subscription service may type a brand name of an article via a keyboard provided on the display of the device associated with the user, the name of the brand may be the user interface activity data. In yet another example, the user of the apparel rental subscription service may click on one or more selections associated with one or more articles displayed on a display of the user device, and the one or more selections may be the user interface activity data. The one or more selections may be in a form of a link, button, or hyperlink. The user interface activity data may be one or more logs associated with the apparel rental subscription service (e.g., clicking events when a user adds an article into his/her virtual wardrobe) collected from an application provided by the apparel rental subscription service. For example, when a user opens the application provided by the apparel rental subscription service, she/he may provide her/his choices of article brands, sizes, billing zip code, and editor (e.g., user preferences) during the activation process. The user may then start adding articles into her/his virtual wardrobe provided in the application. The articles chosen by the user may be associated with or identified by identifiers stored in one or more databases. To simulate a new user situation (e.g., a new user of the apparel rental subscription service first opens the application), customer/user interface activity data may be split into training customer/user interface activity data (e.g., 80% of user interface activity data) and testing customer/user interface activity data (e.g., 20% of user interface activity data).

Step 306 may include determining, via the one or more processors, a rank of one or more articles based on the prediction model by inputting at least one of the user data, the user article data, or the user interface activity data. The rank may indicate a level of preference of the user for the one or more articles. The higher the level of preference of the user for an article or article category, the higher the scores of the rank of the article or article category. For instance, the higher the probability that a given article will be selected by the user, the higher the scores of the rank that may be determined or assigned to the given article, and the higher the level of preference that may be determined or assigned to the given article. In one example, the more frequently that a user interacts with an image of an article or article category (e.g., a user clicks multiple times on a skirt), the higher the rank the article or article category may be, based on the higher level of preference that the user shows for the article or article category.

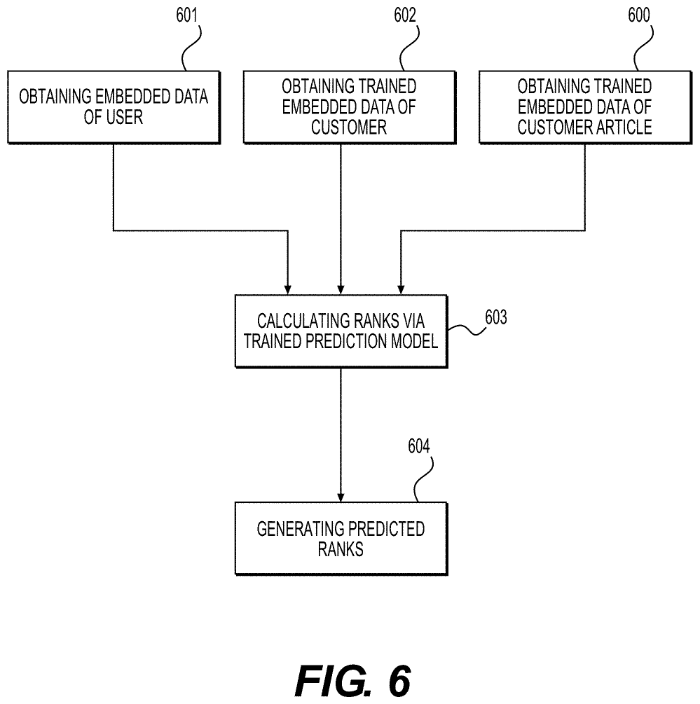

Once the prediction model is trained (e.g., as described with respect to step 304), embedded data may be input into the prediction model. FIG. 6 depicts an exemplary flowchart illustrating the application of the trained prediction model, according to one or more embodiments. The method may include a step 600 of obtaining trained embedded data of customer article (e.g., post-trained embedded article representation graph as discussed in FIG. 5B), a step 601 of obtaining embedded data of a targeting new user (e.g., embedded user data or embedded targeting new user representation graph), a step 602 of obtaining trained embedded data of a customer (e.g., post-trained embedded customer representation graph as discussed in FIG. 5A), a step 603 of calculating ranks via the trained prediction model, and a step 604 of generating predicted ranks. The embedded data of a user may not be random. When the prediction model is being trained, the embedded data of a user or article may not be random and may be fixed. Once training of the prediction model is performed, the embedded data may encode the mathematical representation of a given user's preference toward any given article. When the user first interacts with the application, the model, upon ingestion of the user data, user article data, along with the embedded data (e.g., trained embedded user/customer data and article data) obtained from FIG. 5A, can make a prediction of what articles are more suitable for the user. FIG. 6 may be an example of determining a rank of one or more articles based on the prediction model, as described in step 306 of FIG. 3.

Step 307 may include obtaining, via the one or more processors, environmental data including values of one or more environmental factors. The one or more environmental factors may include at least one of a season factor, a trend factor, or an economic factor. The season factor may include seasonal impact on renting the one or more articles. For instance, during the winter season, outerwear and sweaters may be preferable as compared to T-shirts or short pants. The trend factor may include information regarding one or more trending articles (e.g., articles or article characteristics, such as style, colors, etc., that have recently been selected at high rates by other users, or that have been considered to be in fashion by the professional merchandisers). For instance, such information may indicate that white colored clothing is currently trending, and/or is expected to trend during the coming winter season. The economic factor may include any suitable business performance indicators related to apparel rental subscription services, including, for example, revenue or profit associated with the fashion industry generally, or, more particularly, the inventory to sales ratio of a given article category, or current inventory level, or historical articles' rating in the apparel rental subscription services. The economic factor may include a key performance index for an apparel rental subscription service to prioritize articles shown to a user/customer, including current inventory level, historical articles' rating, and/or the chance of being worn.

Step 308 may include providing, to the user, the personalized user interface associated with the apparel subscription application to the user based on the rank of the one or more articles and the environmental data. The personalized user interface may include a list of articles based on the rank determined in step 306. The personalized user interface may be dynamically updated or adjusted in real-time. For instance, the personalized user interface may be different between day 1 and day 3 because additional user interface activity data is collected by the prediction model. The personalized user interface may include a personalized web page showing information related to a rank of one or more articles. The personalized user interface may include, but is not limited to, one or more images of one or more articles based on the rank (the one or more articles being articles which may be relatively more likely to be preferred by the user); news or articles related to the one or more articles; prices and brands of the one or more articles; information regarding renting the one or more articles (e.g., a recommended location or time to wear an article); possible substitute or compatible items for the one or more articles, and so forth. The rank of the one or more articles may include a re-rank of the one or more articles, so in the personalized user interface, the locations of the one or more images of the one or more articles may vary based on the re-rank of the one or more articles. Although articles, such as wearable items and/or apparel, is described herein as an example, the method can be utilized to provide personalized user interface for other products. The product may be any item or service sold by a merchant.

The method may further include updating the personalized user interface within a predetermined period of time. The predetermined period of time may be at least 1 day, 1 week, 1 month, 1 quarter, 1 year or longer. In other embodiments, the predetermined period of time may be at most 1 year, 1 quarter, 1 month, 1 week, 1 day or shorter. The predetermined period of time may be determined based on arrival time of one or more trending articles to the entity providing the apparel rental subscription services. The arrival time may be the time when new or trending articles arrived at the entity providing the apparel subscription services. For instance, if the arrival time of one or more trending articles is every month, then the predetermined period of time is one month.

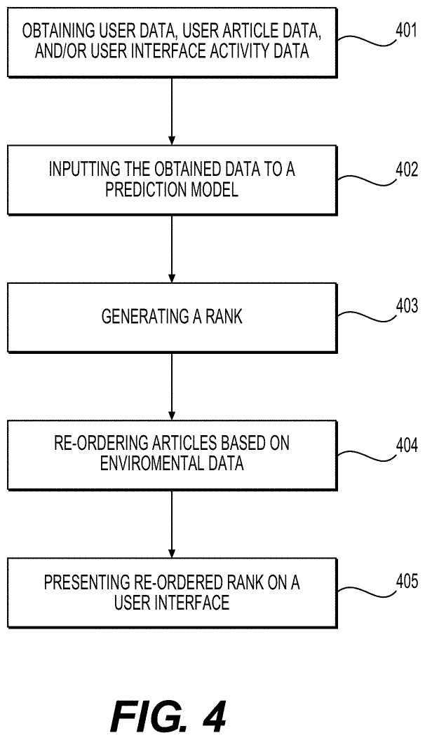

FIG. 4 depicts another exemplary flowchart illustrating a method for providing a personalized user interface to a user. The method may include a step 401 of obtaining user data, user article data, and user interface activity data, a step 402 of inputting the obtained data (e.g., user data, user article data, and user interface activity data) into a prediction model, a step 403 of generating a rank of one or more articles via the prediction model, a step 404 of re-ordering the one or more articles in the rank based on environmental data, and a step of 405 of presenting the re-ordered rank on a user interface. The re-ordered rank may be presented on a personalized user interface. Details of the user data, user article data, user interface activity data, prediction model, the rank, environmental data, and rank are described elsewhere herein. The process illustrated in FIG. 4 may be repeated to match a certain schedule. This schedule may be the launch schedule of new articles to the apparel rental subscription service. For example, a given tenant in the apparel rental service may launch or release new articles daily. Hence, the process illustrated in FIG. 4 may be repeated to match this schedule.

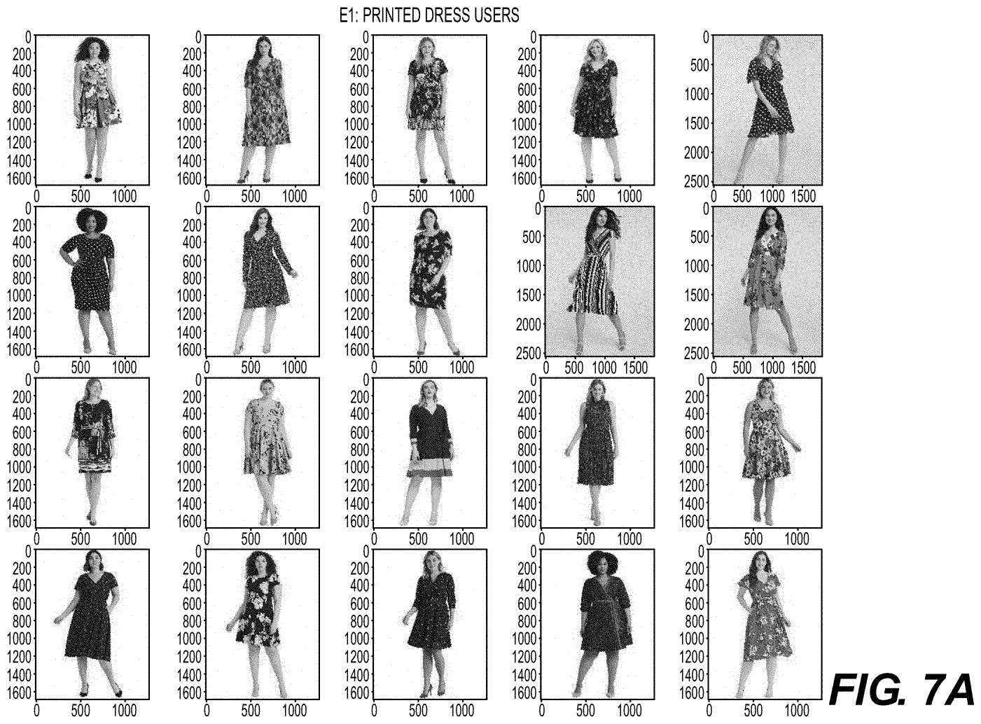

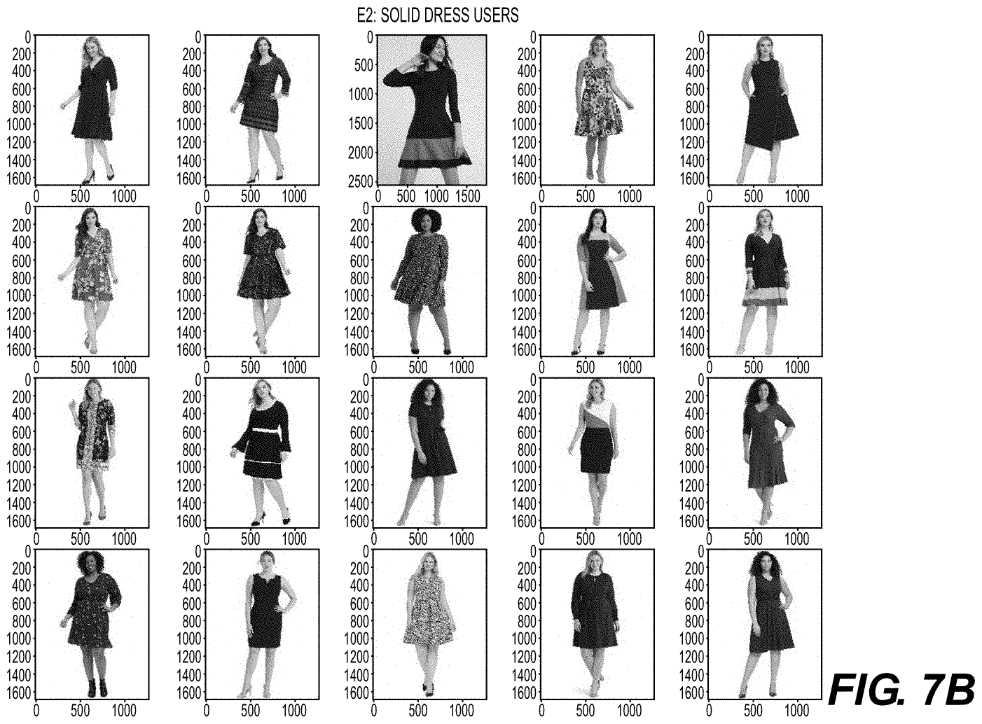

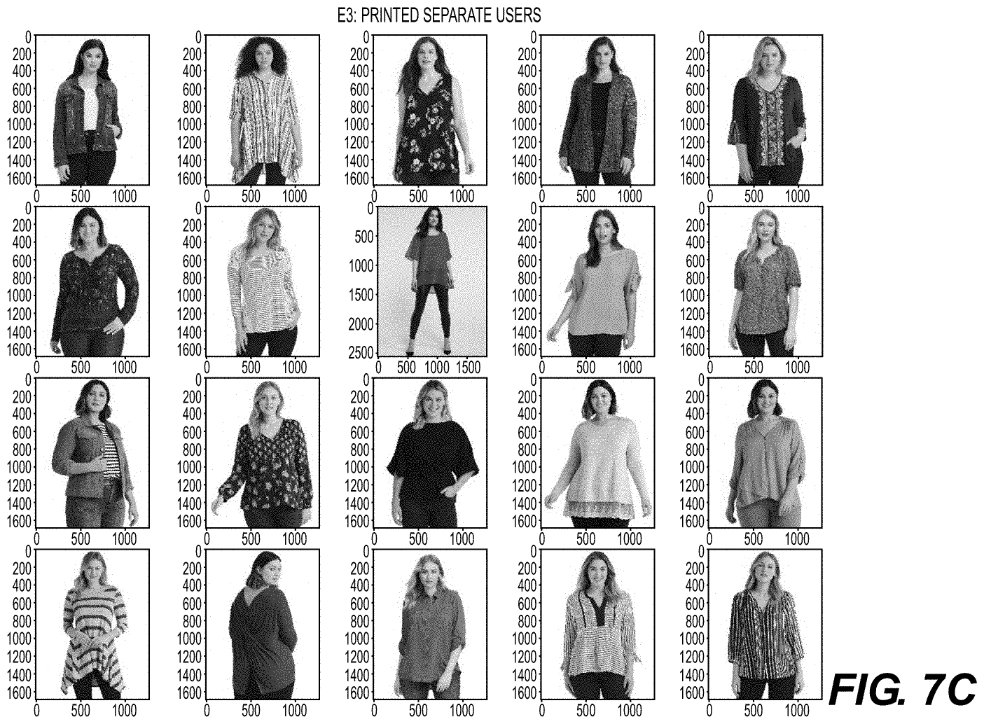

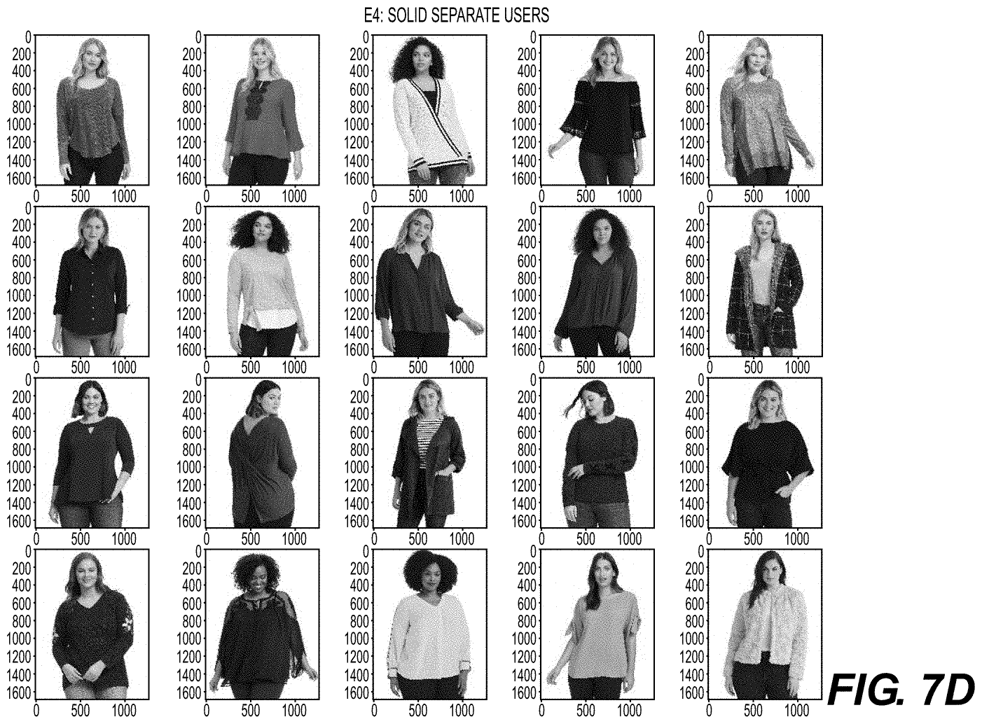

FIGS. 7A-7D depict a plurality of exemplary personalized user interfaces for different users. For example, FIG. 7A may represent a top 20 choices for articles for editor 1 (e.g., printed dress users), FIG. 7B may represent a top 20 choices for articles for editor 2 (e.g., solid dress users), FIG. 7C may represent a top 20 choices for articles for editor 3 (e.g., printed separate users), and FIG. 7D may represent a top 20 choices for articles for editor 4 (e.g., solid separate users). The editor may refer to user's preference of articles or article categories. Table 1 below may describe results for control data and test data for different editors. The control data from the control group may represent the scenario where the articles are curated by a human. The test data from the test group may represent the scenario where the articles are generated by the recommendation engine. One exemplary business metric for apparel rental subscription services may be to reduce the percentage of out-of-stock articles, thereby increasing the chance of articles being available to users/customers and providing an improved user experience. For example, editor 1 (E1) shows the model function well because the difference between control and test for percentage of size out-of-stock is 0.01. As shown in Table 1, percentage of size out-of-stock is statistically lower for the personalized user interface generated by the recommendation engine, by surfacing (e.g., presenting to the user) more available older, but relevant, articles.

TABLE 1

| Editor | Group | Percentage out-of-stock | Editor | P-value |
|---|---|---|---|---|
| E1 | Control | 0.15 | E1 | 1.00E−04 |
| E1 | Test | 0.14 | E2 | 7.00E−11 |
| E2 | Control | 0.19 | E3 | 9.00E−07 |
| E2 | Test | 0.15 | E4 | 1.00E−09 |
| E3 | Control | 0.16 | | |
| E3 | Test | 0.14 | | |
| E4 | Control | 0.18 | | |
| E4 | Test | 0.15 | | |

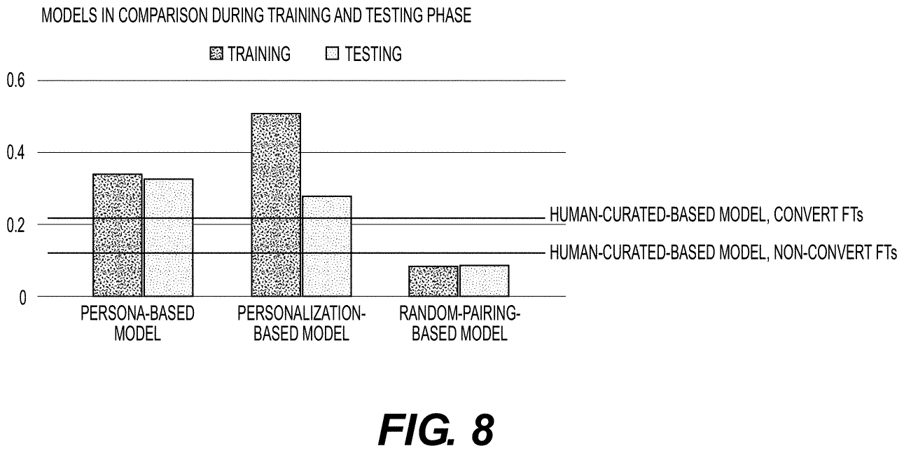

FIG. 8 depicts a comparison of a plurality of exemplary models associated with a method for providing a personalized user interface to a user. The plurality of models may include persona-based models, which may utilize customer persona; personalization-based models, which may utilize customer persona and other data associated with customer; random-selection-based models, which may randomly (e.g., in a non-personalized manner) pair customers/users and one or more articles to provide a baseline for comparison with the persona-based and personalization-based models; and human-curated new personalized user interface baselines (represented as horizontal lines in FIG. 8), which may treat human curated personalized user interface as recommendation baselines for evaluation purposes. As can be seen in FIG. 8, the human-curated personalized user interface baseline may perform better than random-selection-based models (e.g., 1.8 times better for non-converted free trials (FTs), and 2.5 times better for converted FTs). Persona-based recommendation models, such as the models described herein, may perform 2.2 times better than human-curated personalized user interface for non-converted FTs, and 1.6 times better for converted FTs (3.8 times better than random-selection-based models). Personalization-based recommendation models may show overfitting. Overfitting may be a modeling error that occurs when a function is too closely fit to a limited set of data points.

At any stage of providing personalized user interface, the method may further include storing data (e.g., customer data) for subsequent analysis. The stored data may have an expiration period. The expiration period may be at least 1 day, 1 week, 1 month, 1 quarter, 1 year or longer. In other embodiments, the expiration period may be at most 1 year, 1 quarter, 1 month, 1 week, 1 day or shorter. The subsequent analysis may include analyzing the data to update the personalized user interface.

Merchandisers or employees, who may be responsible for curation of personalized user interface of apparel subscription services for each persona, can use the method and system described herein in a semi-automatic or a fully-automatic mode. For a semi-automatic mode, personalized user interfaces, generated by the prediction model at a specified refresh rate, may be the reference (data source) for merchandisers or employees, who can rapidly make final arrangement of article categories, accounting for aesthetic quality, seasonality, or ad-hoc special sale events, before providing the personalized user interface to users of the apparel rental subscription service. For a fully-automatic mode, personalized user interfaces may be completely provided by the prediction model and provided at a specified refresh rate to users of the apparel rental subscription service.

In general, any process discussed in this disclosure that is understood to be computer-implementable, such as the processes illustrated in FIG. 3-6, may be performed by one or more processors of a computer system or a server system 102, as described above. A process or process step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or any suitable types of processing unit.

A computer system, such as a server system 102, may include one or more computing devices. If the one or more processors of the server system 102 are implemented as a plurality of processors, the plurality of processors may be included in a single computing device or distributed among a plurality of computing devices. If a server system 102 includes a plurality of computing devices, the memory of the server system 102 may include the respective memory of each computing device of the plurality of computing devices.

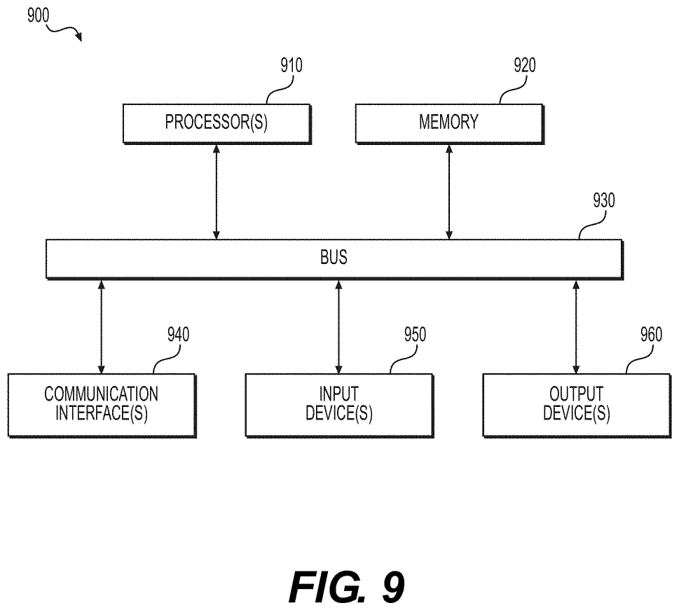

FIG. 9 illustrates an example of a computing device 900 of a computer system. The computing device 900 may include processor(s) 910 (e.g., CPU, GPU, or other such processing unit(s)), a memory 920, and communication interface(s) 940 (e.g., a network interface) to communicate with other devices. Memory 920 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 920. The computing device 900 may, in some embodiments, further include input device(s) 950 (e.g., a keyboard, mouse, or touchscreen) and output device(s) 960 (e.g., a display, printer). The aforementioned elements of the computing device 900 may be connected to one another through a bus 930, which represents one or more busses. In some embodiments, the processor(s) 910 of the computing device 900 includes both a CPU and a GPU.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claims require more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

1. A computer-implemented method for providing a personalized user interface to a user, the method comprising:
obtaining, via one or more processors, customer data including customer identification data of at least one customer of an apparel transaction application, the customer identification data including customer demographic data of the at least one customer;
obtaining, via the one or more processors, customer article data including article information associated with the at least one customer of the apparel transaction application;
obtaining, via the one or more processors, customer interface activity data of the at least one customer, customer interface activity data including one or more interactive activities between the at least one customer and a customer interface associated with the apparel transaction application, wherein the one or more interactive activities include at least one of an action of clicking a link, an action of typing a search term, or an action of selecting a filter performed by the at least one customer;
training, via the one or more processors, a prediction model based on the customer data, the customer article data, and the customer interface activity data of the at least one customer;
obtaining, via the one or more processors, at least one of user data, user article data, or user interface activity data of a user of the apparel transaction application;
determining, via the one or more processors, a rank of one or more articles based on the trained prediction model by inputting the at least one of the user data, the user article data, or the user interface activity data, the rank indicating a level of preference of the user regarding the one or more articles;
obtaining, via the one or more processors, environmental data including values of one or more environmental factors, the one or more environmental factors including at least one of a season factor, a trend factor, or an economic factor;
updating, via the one or more processors, the ranked one or more articles via the trained prediction model based on the obtained environmental data including values of the one or more environmental factors; and
providing, to the user, the personalized user interface associated with the apparel transaction application to the user based on the updated one or more articles.

2. The computer-implemented method of claim 1, further including, prior to training the prediction model, converting the customer data and the customer article data to embedded customer data and embedded article data, respectively.

3. The computer-implemented method of claim 2, further including training the prediction model based on the embedded customer data, the embedded article data, and the customer interface activity data of the at least one customer.

4. The computer-implemented method of claim 1, wherein the customer data is represented as a sparse vector initialized with randomly generated numbers and having vector elements defining possible article categories, one or more customer locations, and/or possible selections of article brands and sizes.

5. The computer-implemented method of claim 1, wherein training the prediction model includes clustering the at least one customer based on the customer interface activity data, and wherein the customer interface activity data is provided as one or more logs and includes at least one of a number of clicks by the at least one customer in the customer interface to certain article categories, a brand name of an article typed by the at least one customer in a search in the customer interface, or one or more selections associated with one or more articles and clicked by the at least one customer in the customer interface.

6. The computer-implemented method of claim 1, wherein the user data includes user identification data of the user.

7. The computer-implemented method of claim 1, wherein the user article data includes article information associated with the user of the apparel transaction application.

8. The computer-implemented method of claim 1, wherein the training the prediction model includes training the prediction model with one or more loss functions.

9. The computer-implemented method of claim 1, further including updating the personalized user interface within a predetermined period of time.

10. The computer-implemented method of claim 9, wherein the predetermined period of time is determined based on arrival time of one or more trending articles.

11. The computer-implemented method of claim 1, wherein the one or more environmental factors includes a season factor, the season factor indicating seasonal impact on renting the one or more articles.

12. The computer-implemented method of claim 1, wherein the one or more environmental factors including a trend factor, the trend factor describing information regarding one or more trending articles.

13. A computer system for providing a personalized user interface to a user, comprising:
a memory storing instructions; and
one or more processors configured to execute the instructions to perform operations including:
obtaining customer data including customer identification data of at least one customer of an apparel transaction application, the customer identification data including customer demographic data of the at least one customer;
obtaining customer article data including article information associated with the at least one customer of the apparel transaction application;
obtaining customer interface activity data of the at least one customer, customer interface activity data including one or more interactive activities between the at least one customer and a customer interface associated with the apparel transaction application, wherein the one or more interactive activities include at least one of an action of clicking a link, an action of typing a search term, or an action of selecting a filter performed by the at least one customer;
training a prediction model based on the customer data, the customer article data, and the customer interface activity data of the at least one customer;
obtaining at least one of user data, user article data, or user interface activity data of a user of the apparel transaction application;
determining a rank of one or more articles based on the trained prediction model by inputting the at least one of the user data, the user article data, or the user interface activity data, the rank indicating a level of preference of the user regarding the one or more articles;
obtaining environmental data including values of one or more environmental factors, the one or more environmental factors including at least one of a season factor, a trend factor, or an economic factor;
updating the ranked one or more articles via the trained prediction model based on the obtained environmental data including values of the one or more environmental factors; and
providing, to the user, the personalized user interface associated with the apparel transaction application to the user based on the updated one or more articles.

14. The computer system of claim 13, wherein training the prediction model includes clustering the at least one customer based on the customer interface activity data.

15. The computer system of claim 13, wherein the user article data includes article information associated with the user of the apparel transaction application.

16. The computer system of claim 13, wherein the one or more environmental factors includes a season factor, the season factor indicating seasonal impact on renting the one or more articles.

17. The computer system of claim 13, wherein the one or more environmental factors including a trend factor, the trend factor describing information regarding one or more trending articles.

18. A non-transitory computer readable medium for use on a computer system containing computer-executable programming instructions for performing a method of providing a personalized user interface to a user, the method comprising:
obtaining, via one or more processors, customer data including customer identification data of at least one customer of an apparel transaction application, the customer identification data including customer demographic data of the at least one customer;
obtaining, via the one or more processors, customer article data including article information associated with the at least one customer of the apparel transaction application;
obtaining, via the one or more processors, customer interface activity data of the at least one customer, customer interface activity data including one or more interactive activities between the at least one customer and a customer interface associated with the apparel transaction application;
training, via the one or more processors, a prediction model based on the customer data, the customer article data, and the customer interface activity data of the at least one customer;
obtaining, via the one or more processors, at least one of user data, user article data, or user interface activity data of a user of the apparel transaction application;
determining, via the one or more processors, a rank of one or more articles based on the trained prediction model by inputting the at least one of the user data, the user article data, or the user interface activity data, the rank indicating a level of preference of the user regarding the one or more articles;
obtaining, via the one or more processors, environmental data including values of one or more environmental factors, the one or more environmental factors including an economic factor including a current inventory level of the one or more articles;
updating, via the one or more processors, the ranked one or more articles via the trained prediction model based on the obtained environmental data including values of the one or more environmental factors; and
providing, to the user, the personalized user interface associated with the apparel transaction application to the user based on the updated one or more articles.

19. The non-transitory computer readable medium of claim 18, wherein the one or more environmental factors further includes a season factor, the season factor indicating seasonal impact on renting the one or more articles.

20. The non-transitory computer readable medium of claim 18, wherein the one or more environmental factors further includes a trend factor, the trend factor describing information regarding one or more trending articles.
